(19) United States
(12) Patent Application Publication
(10) Pub. No.: US 2019/0308310 A1
(43) Pub. Date: Oct. 10, 2019

(54) Configurable tool set for manipulating objects

(71) Applicant: Mark David Gusack, Huntington, WV (US)

(72) Inventor: Mark David Gusack, Huntington, WV (US)

(21) Appl. No.: 15/932,707

(22) Filed: Apr. 9, 2018

(51) Int. Cl. B25G 1/04; B25G 1/10; B25G 1/06

(52) U.S. Cl. CPC B25G 1/04; B25G 1/107; B25G 1/06; B25G 1/10

(57) ABSTRACT

The present invention defines a unique structure and methodology for creating a plurality of configurable and extensible tools that can be affixed to a plurality of digits and equipment to form tool sets for working more easily with objects.

### CROSS-REFERENCE TO RELATED APPLICATIONS

This application claims the benefit of provisional patent application Ser. No. 62/602,079, filed 2017 Apr. 10 by the present inventor.

### FEDERALLY SPONSORED RESEARCH

Not Applicable

### SEQUENCE LISTING OR PROGRAM

Not Applicable

### BACKGROUND

### Field Of Invention

This invention relates to a unique structure and methodology creating a configurable and extendible set of tools that can be affixed to fingers, thumbs, prostheses, machines, and robotic devices to provide the means to more easily work with objects.

### Description of Prior Art

A wide variety of hand held tools have been invented in the past to spear, grasp, pick up, move, manipulate, modify, and release (herein below referred to as work) things of various types, shapes, consistency, weight, and sizes (herein below referred to as objects). This includes but is not limited to such fields as healthcare, manufacturing, artwork, writing, woodworking, construction, and even eating. For many purposes, using the thumb and a plurality of fingers (herein below referred to as digits) to hold a tool has been adequate. However, small objects, delicate objects, and potentially dangerous objects can be difficult to work with, especially if the object is difficult to reach, fine motor skills are lacking, the fingers are too big, or too short, or, one or more digits have been lost or are otherwise nonfunctional. More recently, the development of automated machines and robotics has created a need for replacing devices (herein below referred to as configurability) and modifying their reach and/or angle (herein below referred to as extensibility) while advances in prosthetics has led to the need for specialized attachments. (Prostheses, machines, and robotic devices are herein below referred to as equipment). The present invention reveals a unique structure and methodology for providing a configurable and extensible tool set that can be affixed to a plurality of digits and equipment to work with objects with greater capability, and functionality.

### A Review of Prior Art

Although there are innumerable inventions that allow for reconfiguring and extending utensils and tools, almost all require the user grasp the tool and squeeze, twist, brush, or carry out some other manipulation to work with objects. This often requires the use of muscles enervated for more gross movements and makes fine motor manipulation of the tool difficult. A prior art search produced many inventions that attempt to solve some but not all these problems. For example, U.S. Pat. No. 3,555,819 and its sister, U.S. Pat. No. 3,399,456 reveal a design for finger-held tools. In these two patents, individual tools are described and illustrated that can be mounted on a plurality of fingers but not the thumb. None of the tools is configurable. Furthermore, the first patent states that “the tools are alternately brought against the thumb to perform an associated operation such as cutting, bending, positioning, or gripping”. That means only those fingers on the same hand as the thumb can be used while the thumb must be kept free. Furthermore, the means by which a tool is affixed to or removed from a finger involves a complex strap necessitating several steps which is also not suitable for affixing to equipment. Then, there are U.S. Pat. Nos. 2,151,846, 2,418,638, 2,788,817, and 3,505,700 which reveal a “thimble” that fits adjustably over a finger. One allows for changing tools. However, none of these inventions include a shaft either fixed or configurable, nor a means of angling attached tools to suit intended use. In addition, the second patent requires the thimble be rotated around the finger by the thumb and so, the thumb cannot be fitted with a tool and used in concert with one or more fingers in working with objects. In fact, none of these patents allows for the attachment of a plurality of tools to a plurality of digits or equipment to create a tool set. U.S. Pat. No. 7,229,346 covers a finger-griping sleeve formed from a spirally wrapped spring tube but, does not address any of the other parts of the present invention.

There is little in the way of a simple means of attaching tools to and removing them from machines or robots without extensive mechanical work. For example, U.S. Pat. No. 4,627,785 describes extending fingers that are hollow allowing for attachment. However, this requires a “computer controlled locking mechanism” described in an entirely separate U.S. Pat. No. 4,591,198. Then, there is U.S. Pat. No. 4,543,032 which is representative of changeable robotic finger tools. It describes a highly complex and specialized griping and release mechanism that cannot be used on human or prosthetic digits.

U.S. Pat. Nos. 3,802,302 and 3,490,078 are representative of tool holding prosthetic devices which are designed to replace the entire hand, not to attach to a plurality of prosthetic digits on a prosthetic hand, let alone a real hand or other equipment. U.S. Inventions such as U.S. Pat. No. 2,706,296 cover entire prosthetic hands but do not provide a means for easily detaching the tip of a prosthetic digit and replacing it with a tool or attaching a tool directly to the tip of a prosthetic digit. U.S. Pat. No. 6,238,358 B1 includes a configurable set of tools that can be attached to a flexible medical device that can be placed on a hand or prosthetic hand but does not attach to individual digits.

U.S. Pat. No. 2,685,880 reveals a compass-forceps that includes a “holder” into which the user can slip the pointer finger to gain better control. The absence of this part does not render the forceps nonfunctional and requires the thumb to operate. Furthermore, it does not allow for attachment to a plurality of digits or equipment. U.S. Pat. Nos. 2,846,766, 2,889,160 and 3,834,021 suffer from similar problems and involve complex methods of attachment to the hand.

As far back as the nineteenth century inventors have been struggling with improving how we hold utensils and writing tools. For example, U.S. Pat. No. 565,374 reveals a pen held to the hand using a palm strap and a plurality of rings that are fixed in size to receive the ring and little finger. The result is a single use tool where the means of affixing to the hand is cumbersome. U.S. Pat. No. 503,011 reveals a simpler pen or pencil holder consisting of a single adjustable finger ring attached to a holder. Again, there is no configurability or extensibility. For example, the invention prevents the user from changing the angle of the pen or pencil. More recently many configurable eating utensils have been invented such as U.S. Pat. No. 4,325,187 where a spoon is attached to a holder that straps to a hand and the spoon's orientation can be adjusted using a hinge. However, this invention does not utilize the fingers, nor does it provide configurability.

Historically, many cultures have utilized devices called chop sticks to eat. This involves using two narrow straight rods held in one hand to grasp, pick up, move, and release a wide variety of foods. Their design requires they be manipulated in concert to pinch a piece of food, lift it up, and release it into the mouth. In its present state, the chop stick provides a less than ideal grasping surface allowing round, slippery, irregular, granular, and/or friable pieces of food to drop before reaching the mouth. Furthermore, it provides a limited means of manipulating large pieces of food prior to placement in the mouth necessitating dividing food it into smaller pieces with another utensil before eating. Furthermore, chop sticks require a significant coordination of the muscles of the hand to get the narrow straight rods to work properly and this leads to frequent re-adjustment in the hand to optimize use. Prior art search produced numerous patents describing some form of hinge mechanism that couples the two rods together or provides another means to stabilized them in the hand. For example, U.S. Pat. Nos. 9,458,322 B2, 7,182,378 B25, 6,454,328 B1, 486,029, and 4,721,334 to name a few. None of these and others examined reveal a configurable tool set that can be affixed to digits and used to eat food.

Therefore, virtually all prior art lacks the capability of creating configurable tool sets that allow for an attachment to a plurality of digits or equipment providing a plurality of uses. The prior art that most closely approaches the present invention is U.S. Pat. No. 4,821,417 whereby a shaft “which is terminated by any of an assortment of removable tools and utensils.” that is affixed to a hand”, not digits, and requires a handle that is bent around the hand, such that, “once bent, . . . remains in its deformed position.” This invention excludes attachment and removal from individual digits or equipment and precludes using a plurality of tools or utensils by affixing more than one to the same hand. Another U.S. Pat. No. 4,809,435 reveals chop sticks with removable “food engaging member”. However, this invention simply converts a set of chop sticks into a fixed utensil that does not fit onto a digit or other equipment.

For the foregoing reasons and many others to be revealed herein below, there is a need for an improved tool that provides a structure and methodology to work with objects with a greater degree of configurability and extensibility when affixed to either digits or equipment providing a means to work with objects with greater capability, and functionality.

### SUMMARY OF THE INVENTION

Accordingly, it is an object of this invention to provide a unique structure and methodology that solves all of the above said limitations of Prior Art while adding additional capabilities. This is achieved through modularization of the working parts of the present invention to create a plurality of configurable and extensible tools that can be easily affixed to and removed from digits and equipment as revealed herein below to create tools sets.

### BRIEF DESCRIPTION OF DRAWINGS

### Figures

Various other objects, features, and attendant advantages of the present invention will be more fully appreciated as the same becomes better understood when considered in conjunction with the accompanying drawings.

### DRAWINGS

### Reference Numerals and Lines

Each part revealed herein below is identified uniquely by a Page Number indicating the page where it is first revealed, concatenated to two additional Numbers ranging from 01 through 99 to form a unique identifier. This identifier is linked to a part by a simple line. Closely related parts revealed in the same figure are assigned the same number but different alphabetic suffixes ranging from a through z indicating that each is a variation or modification of a part with the same or similar function. Lines ending in arrows indicate an assembly or subassembly of parts referenced in the specifications.

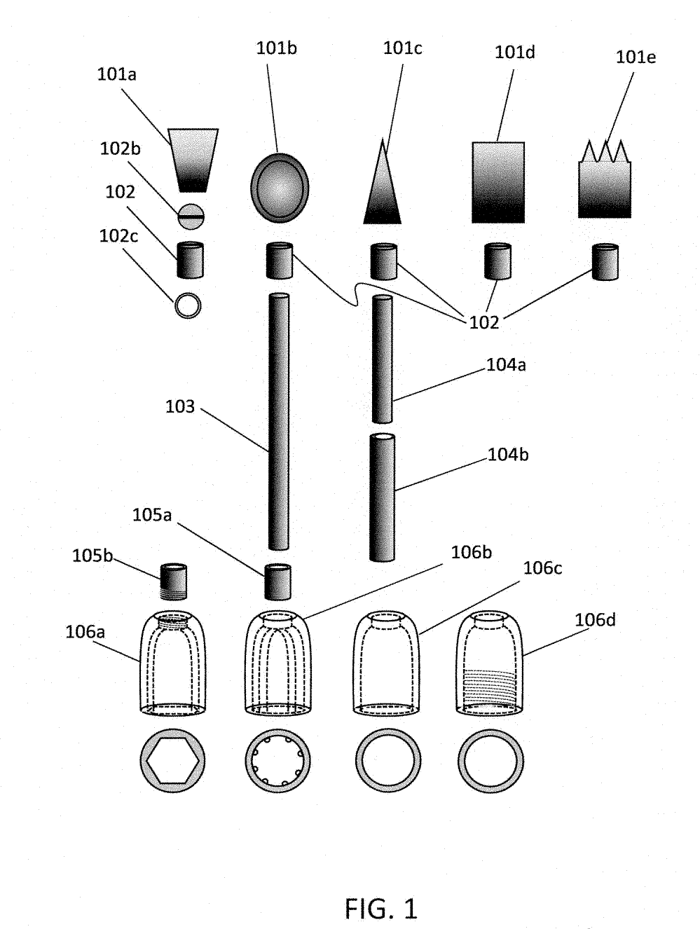

FIG. 1 Shown is an exploded view of a nonexclusive plurality of possible devices of which five are shown that can be assembled to a plurality of upper connectors of which one is shown, that can be assembled to a plurality of shafts of which two are shown, that can be assembled to a plurality of lower connectors of which two are shown, that can be assembled to a plurality of sleeves, of which four are shown, that can be fitted over a plurality of digits and other equipment.

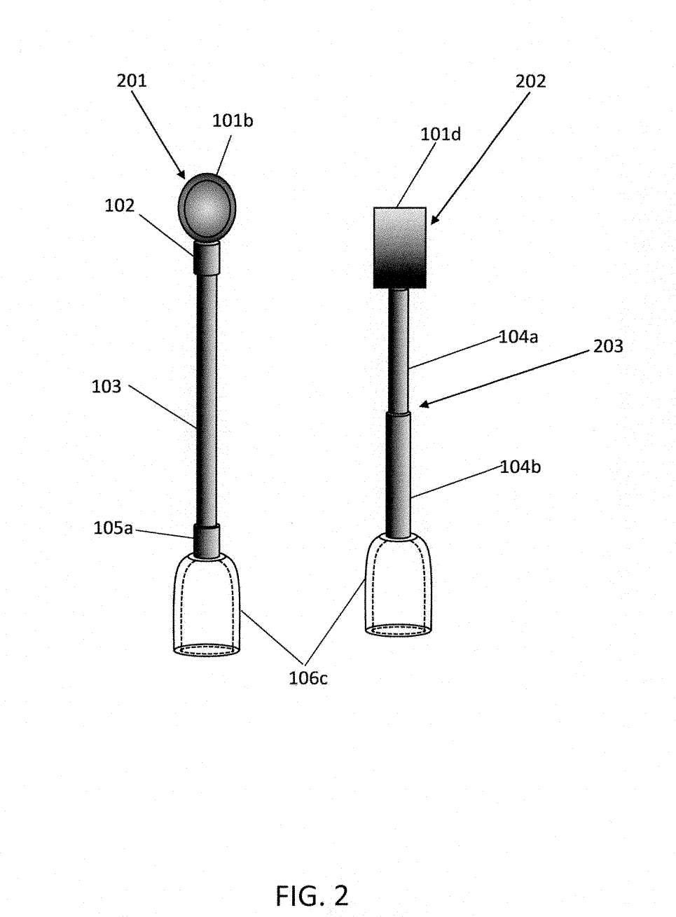

FIG. 2 Shown are two three-dimensional views of a selection of the above said parts assembled into complete tools. One is shown with a fixed shaft and one is shown with a shaft allowing the adjustment of length of the assembled tool. One assembly shows the use of upper and lower connectors. One assembly shows the said connectors can be dispensed with if need be. The two tools together define a tool set.

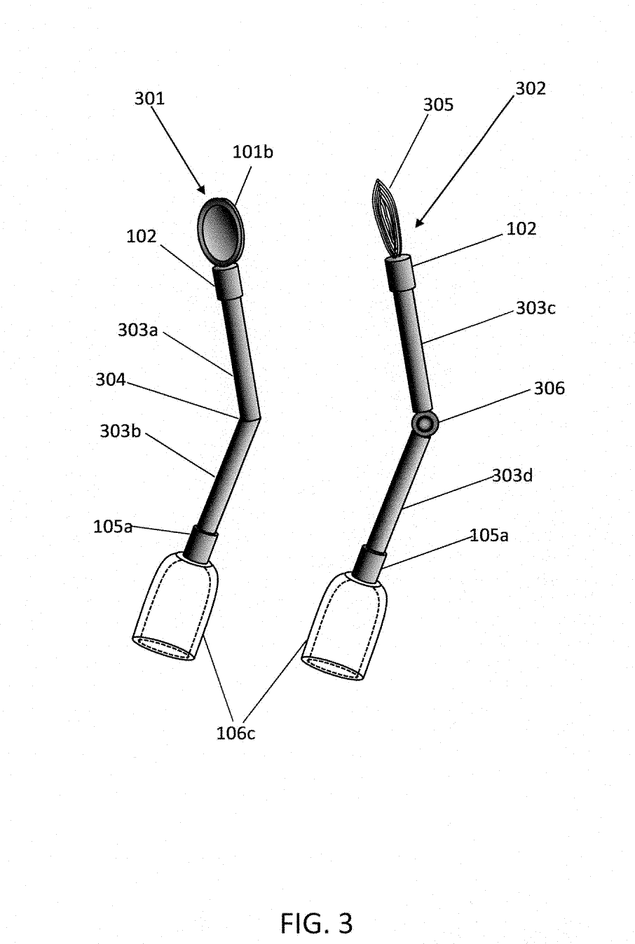

FIG. 3 Shown are two additional three-dimensional views of the above said components assembled into complete tools. One assembly is shown with a shaft with a fixed angle and one assembly is shown with a shaft with joint allowing the adjustment of the angle of the assembled tool. The two tools together define a tool set.

### DETAILED DESCRIPTION OF THE PREFERRED EMBODIMENT

### Multiple Embodiments of Configurable Tools and Tool Set; Exploded View: FIG. 1

Shown in FIG. 1 is a three-dimensional exploded view of preferred embodiments of the present invention. This comprises a plurality of devices (101a, 101b, 101c,101d, 101e) constructed of rigid, semi-rigid, or pliable materials including but not limited to metal, wood, plastic, rubber, fibers, and fabric. In this embodiment the devices shown are: flat wedge shaped for grasping, scraping, or cutting, cup shaped for grasping or picking up, triangular shaped for grasping or spearing, rectangular shaped for grasping or cutting, and serrated for grasping, spearing, or cutting. A person skilled in the art will see that a plurality of additional devices may be fashioned to meet a plurality of needs including but not limited to screw drivers, punchers, brushes, and hooks. Each said device is assembled to one of a plurality of upper connectors (102) constructed of rigid or semi-rigid materials. A slot (102a) is shown manufactured into upper end of the upper connector (102) to accept the lower end of one of a plurality of devices (101a, 101b, 101c,101d, 101e) and the lower end of the upper connector (102) is shown manufactured to create a slot (102b) to accept one of a plurality of shafts (103, 104a) constructed of rigid or semi-rigid materials. A person skilled in the art will see that the lower ends of devices (101a, 101b, 101c,101d, 101e) and the upper end of the upper connector (102a) can be designed and manufactured to allow the affixing of said devices to said upper connector (102) by a plurality of methods including but not limited to friction, threads, screws, clips, spring loaded key slots, welding, and cement allowing said devices (101a, 101b, 101c,101d, 101e) to be assembled temporarily or permanently. A person skilled in the art will also see that the cylindrical slot shown in the lower end (102c) of the upper connector (102) can be smooth, scored with vertical ridges, threaded, or otherwise manufactured to accept and temporarily affix the lower end (102c) of said upper connector (102) to the upper end of a plurality of shafts (103, 104a) which, in turn, can be manufactured to be received. In this embodiment of the invention, a fixed shaft is shown as a straight cylinder (103). However, a person skilled in the art will also see that said fixed shaft can be assembled from a plurality of straight or curved rods with a plurality of cross sections such as a polygon and, furthermore, that the shaft can be manufactured of pliable material to allow for flexing and spring-like action. Furthermore, a person skilled in the art will see that a shaft can be assembled from a plurality of smaller shafts herein below referred to as shaft segments that can be fitted together by a plurality of means like those revealed herein above. In this case, an example is shown consisting of two shaft segments (104a, 104b) whereby the upper end of the lower shaft segment (104b) is manufactured to accept the lower end of the upper shaft segment (104a) such that the upper shaft segment (104a) can be slid up and down inside the lower shaft segment (104b). This relationship can be reversed so that the upper shaft segment (104a) slides up and down over the lower shaft segment (104b). When assembled, the two segments (104a, 104b) form an extensible shaft that can be adjusted to a plurality of lengths. A person skilled in the art will see that the ends of shaft segments (104a, 104b) can be smooth, scored with vertical ridges, spring loaded key slots, threaded, or otherwise manufactured allowing the upper shaft segment (104a) to be affixed to the lower shaft segment (104b) introducing the ability to adjust the total length defined by the shaft segments (104a,104b) when assembled while providing enough stability to temporarily fix said length while further allowing shaft segments (104a,104b) to be separated for additional configurability, extensibility, capability, and functionality through the attachment of a plurality of additional shorter, longer, angled, or articulated shaft segments (also see FIG. 3.). The lower end of either the shaft (103) or shaft segment (104b) can be assembled to the upper end of one of a plurality of possible lower connectors (105a,105b), constructed of rigid or semi-rigid materials, that can be like or identical to the above said upper connector (102). The lower end of one of a plurality of lower connectors (105a,105b) can be assembled to the upper end of one of a plurality of possible sleeves (106a,106b,106c,106d) constructed from a plurality of materials with shape, consistency, and surfacing that allows them to be affixed to a digit or equipment, such that it remains in place during use of the entire assembly. A person skilled in the art will see that a plurality of lower connectors (105a,105b) can be assembled to a plurality of sleeves (106a,106b,106c,106d) by a plurality of methods including but not limited to threads, a screw, clip, spring loaded key slots, welding, and cement so that it they can be either removable or permanently assembled. Furthermore, as shown, the sleeve can be manufactured to be affixed to round, polygonal, or irregular surfaces using ridges, matching polygonal shape, screws, threads, spring loaded key slots or friction. The entire assembly above described is here in below referred to as a tool. A person skilled in the art will see that the upper connector (102) and lower connectors (105a, 105b) can be dispensed with by incorporating their capabilities into the upper and lower ends of said shafts (103, 104a,104b). Said assembled plurality of tools can be used to work with a plurality of objects and provides the means of assembling and disassembling a plurality of devices shafts, connectors, and sleeves to accommodate a plurality of digits and equipment. When at least two of the above said tools are affixed to at least two digits or pieces of equipment, a tool set is created. Furthermore, the number of tools that can be assembled into a tool set is limited only by the number of digits and/or pieces of equipment that can work in concert with each other.

### One First and Second Embodiment of a Configurable Tool Set; Assembled View: FIG. 2

Shown in FIG. 2 are three-dimensional views of two fully assembled nonexclusive embodiments of the present invention. The first tool (201) consists of a cup-shaped device (101b) assembled to one of a plurality of an upper connectors (102) assembled to one of a plurality of shafts (103) assembled to one of a plurality of lower connectors (105a) assembled to one of a plurality of sleeves (106c). The second tool (202) consists of a flat rectangular device (101b) assembled to one of a plurality shaft segments (104a,104b) assembled into an adjustable length shaft (203) further assembled to one of a plurality of a plurality of sleeves (106c).

### One Second and One Third Embodiment of a Configurable Tool Set; Assembled View: FIG. 3

Shown in FIG. 3 is a three-dimensional view of two additional embodiments of the present invention fully assembled. The first tool (301) consists of a cup-shaped device (101b) assembled to one of a plurality of upper connectors (102) assembled to one of a plurality of first shaft segments (303a) assembled to one of a plurality of second shaft segments (303b) to form one of a plurality of fixed angles (304) further assembled to one of a plurality of lower connectors (105a) assembled to one of a plurality of sleeves (106c). A person skilled in the art will see that a plurality of fixed angles (304) can be achieved varying from near zero degrees (0°) to near one hundred-eighty degrees (180°) using a plurality of above said methods. The second tool (302) consists of a flexible brush device (305) assembled to one of a plurality of upper connectors (102) assembled to one of a plurality of first shaft segments (303c) assembled to one of a plurality of adjustable joints (306) assembled to one of a plurality of second shaft segments (303d) that allows the formation of an adjustable angle between the above said two shaft segments (303c,303d) assembled to one of a plurality of lower connectors (105a) assembled to one of a plurality of sleeves (106c). A person skilled in the art will see that the joint (306) can be either a simple hinge that allows rotation in one plane or a ball joint that allows rotation in a plurality of planes. A person skilled in the art will also see that the affixing of a plurality of nonexclusive shaft segment types revealed herein above (104a,104b,303a,303b, 303c,303d) with a plurality of joints (306) would allow the assembly of a shaft with fixed or adjustable length with either fixed adjustable angle and even a combination of all of the above capabilities greatly increasing configurability, extensibility, capability, and functionality; and, therefore, usefulness of the subsequent tool set in working with objects.

### Summary, Ramifications, and Scope

In summary, the various embodiments of the present invention revealed herein above provide a new and unique structure and methodology of manufacturing and assembling tool sets that can be fitted to a plurality of digits and equipment that allows for working with a wide variety of objects including but not limited to food.

Furthermore, the various embodiments of the present invention provide the additional unique benefit of being capable of assembly to a plurality of other devices not shown herein above to form a plurality of additional tools and tool sets including, but not limited to drills, grinders, flash lights, aerosol projectors, writing tools, and laser pointers.

Furthermore, the various embodiments of the present invention provide the additional unique benefit of being capable of assembly to a plurality of other tools to create a plurality of enhanced tools that can be assembled to robotic systems to increase configurability, extensibility, capability, and functionality.

Furthermore, the various embodiments of the present invention provide the additional unique benefit of being capable assembly to a plurality of prostheses to increase configurability, extensibility, capability, and functionality in persons with lost digits, hands, and even feet who have fixed prostheses.

### Other Embodiments of the Invention

The above revealed embodiments and implementations are not meant to limit the scope of the present invention. A person skilled in the art will see that many other unspecified capabilities may be added to the tool set. A first nonexclusive example would be a tool set for rapidly sorting objects too small to be easily handled by the digits or seen without lighting or magnification such as small gemstones, seeds, screws, and electronic or computer components. The assembly of a magnifying device with a light to one of the tools in a tool set solves this problem.

What is claimed is:

1. At least one first tool comprising:
at least one first device; and
at least one first upper connector; and
at least one first shaft; and
at least one first lower connector; and
at least one first sleeve; whereby
the said at least one first device is assembled to the upper end of the said at least one first upper connector; and the lower end of the said at least one first upper connector is assembled to the upper end of the said at least one first shaft; and the lower end of the said at least one first shaft is assembled to the upper end of the said at least one first lower connector; and the lower end of the said at least one first lower connector is assembled to the upper end of the said at least one first sleeve.

2. The above said at least one first tool in claim 1. being affixed to at least one first digit by the lower end of the said at least one first sleeve on at least one first hand or one first piece of equipment, thereby providing the means of working with at least one first object.

3. The above said at least one first tool in claim 1. being reconfigured by:
replacement of the said at least one first device from the said at least one first tool with at least one second device; and/or
replacement of the said at least one first upper connector from the said at least one first tool with at least one second upper connector; and/or
replacement of the said at least one first shaft from the said at least one first tool with at least one second shaft; and/or
replacement of the said at least one first lower connector from the said at least one first tool with at least one second lower connector; and/or
replacement of the said at least one first sleeve from the said at least one first tool with at least one second sleeve whereby;
at least one second tool is created.

4. At least one third tool comprising:
at least one third device; and
at least one third shaft; and
at least one third sleeve; whereby
the said at least one third device is assembled to the upper end of the said at least one third shaft; and the lower end of the said at least one third shaft is assembled to the upper end of the said at least one third sleeve.

5. The above said at least one first tool in claim 4. being reconfigured by:
replacement of the said at least one third device from the said at least one first tool with at least one fourth device; and/or
replacement of the said at least one third shaft from the said at least one first tool with at least one fourth shaft; and/or
replacement of the said at least one third sleeve from the said at least one first tool with at least one fourth sleeve whereby;
at least one fourth tool is created.

6. The above said at least one second tool in claim 3 and/or the above said at least one third tool in claim 4. being affixed to at least one second and/or third digit by the lower end of the said at least one second and/or third sleeve on at least one first hand or one first piece of equipment, which, when combined with the said at least one first tool affixed to said at least one first digit or one first piece of equipment, creates at least one first tool set providing the means of working with at least one second object.

7. At least one fifth tool comprising:
at least one fifth device; and
at least one third upper connector; and
at least one first shaft segment; and
at least one second shaft segment; and
at least one third lower connector; and
at least one fifth sleeve; whereby
the said at least one fifth device is assembled to the upper end of the said at least one third upper connector; and the lower end of the said at least one third upper connector is assembled to the upper end of the said at least one first shaft segment; and the lower end of the said at least one first shaft segment is assembled to the upper end of the said at least one second shaft segment; and the lower end of the said at least one second shaft segment is assembled to the upper end of the said at least one third lower connector; and the lower end of the one said at least third lower connector is assembled to the upper end of the said at least one fifth sleeve whereby the at least one first shaft segment slides along the at least one second shaft segment such that the length of the assembled tool is adjustable.

8. At least one sixth tool comprising:
at least one sixth device; and
at least one fourth upper connector; and
at least one third shaft segment; and
at least one fourth shaft segment; and
at least one fourth lower connector;
at least one sixth sleeve; whereby
the said at least one sixth device is assembled to the upper end of the said at least one fourth upper connector; and the lower end of the said at least one fourth upper connector is assembled to the upper end of the said at least one third shaft segment; and the lower end of the said at least one third shaft segment is assembled to the upper end of the said at least one fourth shaft segment; and the lower end of the said at least one fourth shaft segment is assembled to the upper end of the said at least one fourth lower connector; and the lower end of the said at least fourth lower connector is assembled to the upper end of the said at least one sixth sleeve whereby the said at least one third shaft segment and the at least one fourth shaft segment form a fixed angle.

9. At least one seventh tool comprising:
at least one seventh device; and
at least one fifth upper connector; and
at least one fifth shaft segment; and
at least one sixth shaft segment; and
at least one first joint; and
at least one fifth lower connector;
at least one seventh sleeve; whereby
the said at least one seventh device is assembled to one upper end of the said at least one fifth upper connector; and the lower end of the said at least one fifth upper connector is assembled to the upper end of the said at least one fifth shaft segment; and the lower end of the said at least one fifth shaft segment is assembled to the upper end of the said at least one first joint; and the lower end of the said at least one first joint is assembled to the upper end of the said at least one sixth shaft segment; and the lower end of the said at least the one sixth shaft segment is assembled to the upper end of the said at least one fifth lower connector; and the lower end of the said at least one fifth lower connector is assembled to the upper end of the said at least one seventh sleeve whereby said at least one fifth shaft segment, said at least one sixth shaft segment, and said at least one first joint form an adjustable angle.
